(19) United States
(12) Patent Application Publication
(10) Pub. No.: US 2010/0061404 A1
(43) Pub. Date: Mar. 11, 2010

(54) METHOD FOR STARTING A COMMUNICATION SYSTEM, A COMMUNICATION SYSTEM HAVING A COMMUNICATION MEDIUM AND A PLURALITY OF SUBSCRIBERS CONNECTED THERETO, AND SUBSCRIBERS OF SUCH A COMMUNICATION SYSTEM

(76) Inventor: Josef Newald, Stuttgart (DE)

Correspondence Address: KENYON & KENYON LLP, ONE BROADWAY, NEW YORK, NY, 10004, US

(21) Appl. No.: 12/304,661

(22) PCT Filed: Dec. 3, 2007
(86) PCT No.: PCT/EP2007/063164

§ 371 Date: Aug. 26, 2009

(30) Foreign Application Priority Data
Dec. 22, 2006 (DE) 10 2006 061 278.7
Jan. 15, 2007 (DE) 10 2007 003 126.4

(51) Int. Cl. H04J 3/06

(52) U.S. Cl. 370/503

(57) ABSTRACT

A communication system having a communication medium and at least two subscribers connected thereto is described; the communication system being designed for transmitting data among the subscribers via the communication medium in communication frames of communication cycles via a time-triggered protocol. To accelerate the start of the communication system before the actual data transmission, the communication system has a device for generating at least two different synchronization frames per communication cycle and per channel, in at least one of the subscribers, e.g., in the node AB. For example, the device is designed as two separate communication controllers per transmission channel. As an alternative, the device may also be designed as a simple logic circuit, a so-called application-specific standard product. For generating the at least two different synchronization frames per communication cycle, the subscriber is designed as an active star coupler of the communication system. Data transmission in the communication system is preferably performed using the FlexRay protocol.

### FIELD OF THE INVENTION

The present invention relates to a communication system having a communication medium and multiple subscribers connected thereto. The present invention also relates to a subscriber connected to a communication medium of a communication system. Finally, the present patent application relates to a method for starting a communication system.

### BACKGROUND INFORMATION

Networking of control units, sensor systems, and actuator systems with the help of a communication system using a communication medium, e.g., a bus system, has increased drastically in recent years in the construction of modern motor vehicles and also in mechanical engineering, in particular in the machine tool field, and in automation. Synergy effects due to the distribution of functions among multiple control units as subscribers of the communication system may be achieved in this manner. These are called distributed systems. Communication among various subscribers occurs more and more via a communication medium. The communication traffic on the communication medium, access and reception mechanisms as well as the handling of errors are regulated by a protocol. A known protocol here is the FlexRay protocol, FlexRay protocol specification v2.1 being used at the present moment. A FlexRay communication system is a rapid, deterministic and error-tolerant bus system for use in a motor vehicle in particular. The FlexRay protocol operates according to the time division multiple access (TDMA) method, in which fixed time slots are assigned to the nodes (i.e., the subscribers of the communication system) or to the messages to be transmitted, so that they have exclusive access to the communication medium in these time slots. The time slots, also known as communication frames, recur in a defined communication cycle, so that the point in time at which a message is transmitted over the bus is accurately predictable and thus bus access is deterministic. Other examples of time-triggered communication systems include, for example, time-triggered CAN (TTCAN), time-triggered protocol (TTP), media-oriented systems transport (MOST) bus, and local interconnect network (LIN) bus.

To optimally utilize the bandwidth for message transmission on the bus system, FlexRay subdivides the cycle into a static part and a dynamic part. Fixed time slots are in the static part at the beginning of a bus cycle. Time slots are issued dynamically in the dynamic part. Exclusive bus access there is possible for only a short period of time, for the duration of a so-called minislot. Only if bus access occurs within a minislot is the time slot lengthened by the required amount of time. Thus, only the bandwidth actually required is used.

FlexRay communicates over two physically separate lines at a data rate of maximal 10 Mbit/s per channel. FlexRay may of course also be operated at lower data rates. A total of two channels, i.e., 2×2 lines, are provided. The two channels correspond to the physical layer, in particular the OSI layer model (open systems interconnection reference model). The two channels are mainly for redundant and thus error-tolerant transmission of messages, i.e., the same data are transmitted in parallel on the two channels. However, the channels may also transmit different messages, whereby the data rate would then be doubled. However, this is not yet being done in practice. At the present time, data are mostly transmitted via only one of the two channels, so the other channel is unused.

To implement synchronous functions and to optimize the bandwidth through small distances between two messages, the distributed components in the communication network, i.e., the subscribers, require a joint time base, the so-called global time. For clock synchronization, synchronization messages are transmitted in the static part of the communication cycle, the local clock time of a subscriber being corrected with the help of a special algorithm according to the FlexRay specification, in such a way that all local clocks run in synchronization with a joint global clock.

A FlexRay network node or a FlexRay subscriber contains a subscriber processor, a FlexRay controller, or a communication controller and a bus guardian monitoring the bus. The processor supplies and processes data transmitted by the FlexRay communication controller. Messages or message objects may be configured with up to 254 data bytes, for example, for communication in a FlexRay network.

A subscriber may be a control unit for implementation of a certain functionality, e.g., for controlling a brake for a wheel of a motor vehicle. The term “subscriber” in the sense of the present invention, however, also includes all types of nodes in the communication system, e.g., also an active star node or a star coupler by which a star topology is imparted to the communication medium. For example, star couplers for FlexRay communication systems are known from FlexRay specification v2.1. The design and functioning belong to the specified physical layer (so-called physical layer) of the FlexRay communication system. Active star couplers are important in communication networks in which the communication link and/or the communication medium are split, i.e., have a star topology, and a data signal is to be split among several branches of the communication medium. Furthermore, active star couplers are important when data signals are to be transmitted over complex network topologies and longer distances because they are also able to amplify the signal in addition to or as an alternative to dividing the data signal among multiple branches. Errors in transmission remain limited to one branch due to the use of star couplers.

A corresponding active star coupler (so-called Active Star) for use in a FlexRay communication system is available from Philips Semiconductors, a manufacturer. FlexRay communication controllers of the SJA 2510 type according to specification v2.1 and an ARMS microcontroller are integrated into the known star coupler. Multiple terminals provided on the known active star coupler are connected to the multiple branches of the communication medium. The terminals may be configured either as input for incoming data signals and/or as output for outgoing data signals. The star coupler has a bus driver at each terminal for amplifying an outgoing data signal. An analog data signal incoming at one of the terminals is relayed to a central processing logic unit of the star coupler, which has a computer, e.g., in the form of a field programmable gate array (FPGA), a microcontroller (μC), or a digital signal processor (DSP).

The active star couplers known from the related art from Philips may include bus drivers of the Philips TJA 1080 type, which correspond to those of FlexRay transceiver units (so-called FlexRay nodes). The known star coupler represents a link of multiple transceivers to one hub. A hub relays data incoming from a subscriber or a node of a communication network via a branch of the communication medium to all other subscribers of the communication system and at the same time amplifies the signal to be relayed.

To start the communication system, the subscriber nodes are activated (i.e., supplied with electric current), initialized, and synchronized to global time. Starting of the communication system is also known as “startup.” In contrast with so-called “wakeup,” in which the subscriber nodes of a communication network are ramped up from a “sleep” state, the subscriber nodes are ramped up from the off-state during startup and begin communication, i.e., the first communication cycles take place and the nodes become synchronized (so-called cold start). Subscribers participating in a startup of the communication system are referred to below as cold start nodes. In the related art, at least two cold start nodes are always needed to be able to execute a startup of the communication system.

During startup of the communication system, one of the cold start nodes assumes the role of the leading cold start node. As a rule, the subscriber whose initialization or wakeup is concluded first assumes the role of the leading cold start node. If there is no data traffic on the channels, the leading cold start node will send a so-called collision avoidance symbol (CAS). Through this symbol it communicates to the other cold start nodes that it has assumed the role as leader. Then the first communication cycles take place in which the leading cold start node sends a synchronization frame, a so-called startup frame. According to FlexRay specification v2.1, this is the case during the first four communication cycles. If another cold start node has initiated the startup at the same time and sent the CAS, the nodes detect this and make sure that only one continues the startup. During the first four communication cycles, the other cold start nodes become synchronized to the leading node and begin to send synchronization frames in the fifth cycle. The leading cold start node then has an option in the following communication cycles to become synchronized because it is receiving communication frames from other nodes for the first time. According to FlexRay specification v2.1, this occurs during the fifth and sixth communication cycles. After synchronization in the fifth and sixth communication cycles, the leading cold start node then begins normal data transmission. The other cold start nodes, which are finished with the initialization only after the leading cold start node, begin normal data transmission one cycle later. The non-cold-start nodes have time to become synchronized during the first eight cycles, and begin data transmission in the ninth cycle at the earliest.

One disadvantage of the known method for starting the communication system is that subscribers cannot begin data transmission or synchronization until at least two cold start/startup subscribers are on the network. For synchronization of the local clocks of the subscribers, it is thus necessary for at least two startup subscribers to be activated and finished with initialization. In practice, however, the activation times of the subscribers, i.e., the period of time from activation of the subscriber until conclusion of initialization, are subject to great fluctuations. Activation times are typically in a range of 50 ms to 200 ms. In comparison with that, FlexRay communication cycles are in the range of 1 ms to 16 ms. If one of the cold start nodes is already finished with initialization after 50 ms, but the second fastest cold start node is not finished with initialization until after 200 ms, then the first node must wait 150 ms, which, in a FlexRay communication cycle of 1 ms, corresponds to 150 communication cycles, before the subscribers are synchronizable and may begin data transmission. Until then, the communication system cannot yet be synchronized. In practice, the node activated most quickly must always wait for the second fastest cold start node before synchronization of the local clocks and the actual data transmission may begin some cycles later. The result is sometimes a substantial time lag in starting the communication system.

Another disadvantage occurs due to the fact that each subscriber of the known communication system must have a cold start functionality because it must theoretically participate in the startup of the system (if it is one of the first two nodes to be finished with the initialization).

### SUMMARY

Example embodiments of the present invention accelerate the startup of a time-triggered communication system, i.e., activation, initialization, and synchronization of the subscribers of the communication system, so that the actual data transmission may begin earlier.

To achieve this, it is provided that the communication system shall have means for generating at least two different synchronization frames per communication cycle in at least one of the subscribers. Furthermore, to achieve this, a subscriber includes a device for generating at least two different synchronization frames per communication cycle. Finally, in a method, a subscriber of the communication system being activated and initialized and the subscriber then transmitting at least two different synchronization frames per communication cycle for synchronization, the subscriber being synchronized to one of the two synchronization frames and then being ready for data transmission.

Example embodiments of the present invention provide that a subscriber may be activated and initialized and may then run through the synchronization procedure immediately by itself in isolation and without any waiting time, the procedure for which at least two different synchronization frames are required according to FlexRay specification v.2.1. For synchronization of the subscriber, it is thus no longer necessary for another subscriber to be finished with initialization and to be ready for the synchronization. The two different synchronization frames have previously been generated by two separate cold start nodes in the related art. Synchronization of the first subscriber by itself in isolation is thus made possible according to example embodiments of the present invention by the fact that the subscriber transmits two different synchronization frames per communication cycle.

Following its initialization, the subscriber at first assumes the role of the leading cold start node in the communication network. Since there is no data traffic on the channels (it is the only active node), it transmits a collision avoidance symbol (CAS), communicating through this symbol to the other cold start nodes (not present) that it has assumed the leading role. Then the first four communication cycles take place, during which the subscriber transmits a first synchronization frame (so-called startup frame). Other cold start nodes (not present) have an option during the first four cycles to become synchronized with the subscriber. If another cold start node is simulated in the subscriber, it might be synchronized with the leading subscriber (which has transmitted the first synchronization frames). Alternatively, the first four cycles may also elapse simply unused or the second sync frames may already be transmitted, but in that case subsequent transmission of sync frames could be omitted. Following transmission of the first synchronization frames, the subscriber (or the simulated cold start node) transmits the second synchronization frames during the subsequent two communication cycles. The leading subscriber (which has transmitted the first synchronization frames) now has an option to become synchronized with the simultaneous cold start nodes or the second synchronization frames. In this way, the subscriber may become synchronized to itself to a certain extent during the first six cycles, i.e., the (leading) subscriber which has transmitted the first synchronization frames becomes synchronized with the (simulated) subscriber that has transmitted the second synchronization frames or synchronized with the second synchronization frames. The subscriber is thus synchronized to a global time and may then begin normal data transmission. According to example embodiments of the present invention, the simulated node and the leading node are one and the same subscriber node, so the subscriber becomes synchronized to itself to a certain extent. According to example embodiments of the present invention, two different cold start nodes or parts thereof required for synchronization are simulated in the subscriber at least for the duration of the startup by transmitting two different synchronization frames. In this example embodiment, the at least one subscriber transmitting two different synchronization frames per communication cycle would be fully compatible with the protocol specification used in the communication system.

Although at least two cold start nodes are necessary for a startup of the communication system (according to FlexRay specification v2.1, there are at most three cold start nodes to prevent a clique from developing), according to example embodiments of the present invention, a startup of the communication system may be performed when only one startup subscriber is finished with the initialization. Therefore, delays in starting the communication system may be prevented. In order that communication in the communication system is started with a subscriber that is more or less not present, however, it is important that communication has been started. All other subscribers of the communication network then become synchronized as so-called integrating nodes to the first subscriber. Example embodiments of the present invention are explained with reference to the FlexRay protocol but it is equally applicable to any type of time-triggered communication system in which multiple subscribers or synchronization messages from different subscribers are required for startup.

Another possibility for implementing example embodiments of the present invention is that the at least one subscriber transmitting two different synchronization frames per communication cycle is not compatible with the protocol specifications used in the communication system, at least with regard to startup. This might be implemented, for example, by the fact that after activating the communication system or the at least one subscriber, it starts up immediately, generating a bit pattern immediately after startup and transmitting it via the communication medium as if a communication network having two nodes already existed. To this end, corresponding messages (so-called NULL frames) and synchronization frames (so-called sync frames) must be generated and transmitted via the communication medium. If there is a cycle-dependent checksum formation in the communication system, the messages or synchronization frames must take this fact into account. In FlexRay, for example, there are 64 successive cycles which must be taken into account in forming the checksum. All other subscribers of the communication system may always connect themselves to the (apparently) existing communication network with a “join cold start” and may begin transmitting messages immediately thereafter. It is thus sufficient if only the at least one subscriber has cold start capabilities; the other subscribers need only be able to integrate up to the existing (simulated) communication network and do not require the associated hardware components and software components.

Finally, it is even possible that a simple logic circuit is provided somewhere in the communication system—not necessarily in one of the subscribers of the system—which transmits the two different synchronization frames per communication cycle immediately after activation of the communication system or the circuit, so that other subscribers may synchronize to it. This logic circuit is relatively easily and inexpensively manufacturable. Installed in any time-triggered communication system, it offers the option—and does so within a minimal time after activation—of bringing any type of time-triggered communication system into a state so that subscribers connecting to the simulated network are ready for data transmission without having to run through a startup or a cold start routine according to the specification used.

Example embodiments of the present invention thus make available a simple and inexpensive method of synchronization earlier than in the past because the startup phase is eliminated and only an abbreviated version is run through. It is also possible for the subscribers according to the present invention to be non-FlexRay-compliant with regard to ramping up the communication system. With regard to the actual data transmission via the communication system, however, the subscribers according to example embodiments of the present invention are FlexRay-compliant. This would then mean that the subscribers according to example embodiments of the present invention would ramp up in a non-FlexRay-compliant manner (without startup or with a shortened startup) but would then begin communication according to the FlexRay specification in the normal manner. It is of course also possible that nonsubscribers according to the present invention are also no longer FlexRay-compliant because now they only connect to the existing communication as so-called integrating nodes; according to example embodiments of the present invention, it is no longer necessary for nonsubscribers to perform a cold start themselves.

Non-FlexRay-compliant startup of the communication system may be achieved, for example, by using a simple logic circuit which does not run through the FlexRay cold start but instead behaves as two normal FlexRay nodes would behave together if they were already in a normal operating state (“normal active”). This means that two synchronization frames (so-called startup frames or sync frames) are simply generated, namely so-called NULL frames (frames without usable data; variable null frame indicator=0). This may be achieved by a very simple sequential logic, which thus generates two NULL frames having identifiers, i.e., ID 1 and 2, for example, which are additionally characterized as startup frames. The values for the cycle counter and the CRC (cyclic redundancy check) vary depending on the cycle, i.e., 64 different sequences must be generated and then it begins again.

### BRIEF DESCRIPTION OF THE DRAWINGS

FIG. 1 shows state transitions in a communication system according to example embodiments of the present invention;

FIG. 2 shows state transitions in a communication system known from the related art;

FIG. 3 shows an example of a network topology of a communication system according to example embodiments of the present invention;

FIG. 4 shows a subscriber according to example embodiments of the present invention of the communication system;

FIG. 5 shows a subscriber according to example embodiments of the present invention of the communication system, and

FIG. 6 shows a subscriber according to example embodiments of the present invention of the communication system.

### DETAILED DESCRIPTION

Example embodiments of the present invention provide a communication system as shown in FIG. 3, for example, and labeled as a whole with reference numeral 1. Communication system 1 has a communication medium 2 which corresponds to the physical layer. Communication medium 2 may include one or more channels and one or more lines or media per channel. Instead of an electrical line, an optical line (e.g., glass fiber), a wireless connection, or an infrared connection may also be used as the physical layer. At least two subscribers are connected to communication medium 2. Communication system 1 shown in FIG. 3 includes subscribers in the form of network nodes 3 and active star couplers 4. On the whole, the exemplary embodiment shown in FIG. 3 includes seven network nodes 3 and two active star couplers 4.

Communication system 1 is designed for transmitting data among subscribers 3, 4 via communication medium 2 in communication frames of communication cycles according to a time-triggered protocol. For example, the FlexRay protocol, preferably the v2.1 specification, is used as the protocol. However, any other time-triggered protocol may also be used as the protocol responsible for data transmission via the communication medium in communication frames of communication cycles.

One of nodes 3 of communication system 1, node AB 3a, includes means for generating at least two different synchronization frames per communication cycle. The at least one subscriber 3a preferably generates exactly two different synchronization frames per communication cycle. Communication system 1 according to the present invention has the advantage that at least two cold start nodes 3 are not necessary for starting communication system 1, as was the case previously in the related art, but instead communication system 1 may be started using node 3a alone, taking into account the protocol specification used. This is a so-called cold start (or startup) of the communication system in preparation for an actual data transmission. Thus communication system 1 is not considered during a development phase, simulation phase, test phase, measurement phase, or calibration phase, but instead this concerns the communication system implemented in a motor vehicle, in a building, or otherwise in a finished manner, to be started in the manner proposed according to example embodiments of the present invention before being used as intended (data transmission). This is important because example embodiments of the present invention are able to greatly accelerate the startup of communication system 1, which is particularly advantageous in starting communication system 1 in preparation for being used as intended because communication system 1 is available for data transmission sooner. In contrast with that, it is possible to wait longer for the system to be started during a development phase, simulation phase, test phase, measurement phase, or calibration phase with no problem.

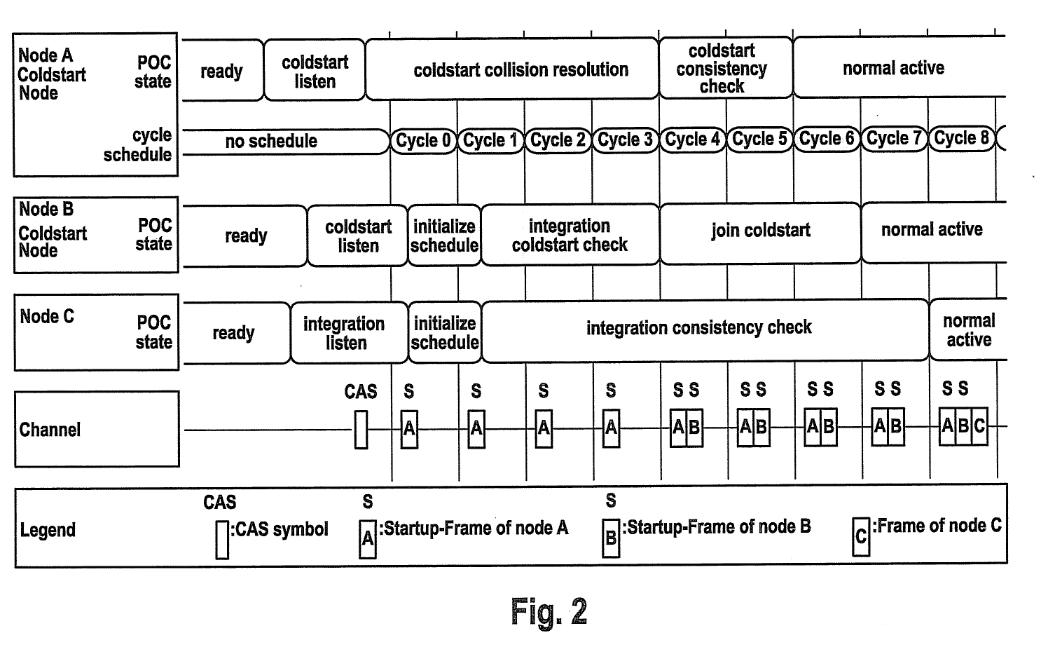

Example embodiments of the present invention are explained in detail below. First, with reference to FIG. 2, the startup sequence in a traditional FlexRay communication system known from the related art is described; in such a system, each subscriber is able to generate only one synchronization frame per communication cycle. FIG. 2 shows only one channel because the sequence is usually synchronous on both channels.

Node A and node B are so-called cold start nodes, which are available for starting the known communication system. One cold start node (node A here) assumes the role of the leading cold start node because it is the first to be finished with the initialization after startup. If there is no data traffic on the channels, node A sends a so-called collision avoidance signal (CAS). Through this symbol, it notifies the other cold start node (node B here) that it has assumed the role of leader. The first four communication cycles (cycle 0 through cycle 3) are run through next, node A transmitting one synchronization frame (so-called startup frame) in each cycle. If the other node B initiates startup at the same time and has sent the CAS, then the nodes detect this and make sure that only one (namely node A) continues the startup. During the first four cycles, the other cold start node B has become synchronized to the leading node (node A) and begins transmitting synchronization frames itself in the fifth cycle (cycle 4). Node A now has the option of becoming synchronized because it is receiving synchronization frames from other nodes for the first time. It performs this synchronization in the fifth and sixth cycles (cycle 4 and cycle 5) and then begins normal data transmission in the next cycle (cycle 6). Node B begins normal data transmission one cycle later (cycle 7). The other non-cold start nodes (node C here) have time to become synchronized during the first eight cycles (cycle 0 through cycle 7) and begin data transmission in the ninth cycle (cycle 8) at the earliest.

It is a disadvantage that the subscribers (cold start nodes A and B) are not started up simultaneously within a FlexRay cluster (computer network) and/or do not finish their initialization equally rapidly. Startup times for subscribers are typically in the range of approximately 50 ms to 200 ms. In comparison with that, a communication cycle in FlexRay is in the range of approximately 1 ms to 16 ms. When the first subscriber (node B) is finished with initialization before the second subscriber (node A) in FIG. 2, the first subscriber does not see a partner, terminates the cold start attempts after a short time and continues to wait for a partner. Only then is the second subscriber activated, ramping up itself as the leading cold start node.

Theoretically in the best case, the intended data transmission, i.e., communication via the communication system, may be initiated after eight communication cycles (condition of the node: normal active). Specifically in FIG. 2, node A may transmit for the first time in the seventh cycle (cycle 6), node B in the eighth cycle (cycle 7) and all other nodes in the ninth cycle (cycle 8). However, it is important that it is possible to transmit at all only when the second fastest of the cold start nodes has been on the network for at least six (or eight) cycles. All other subscribers may neither transmit to nor receive from a partner, i.e., a second cold start node, even if they have already been ready to do so for a long time. In practice, this results in relatively long delays in synchronizing the subscribers and thus in starting the communication system.

This is explained in greater detail below on the basis of the example from FIG. 2 and concrete numerical values. It is assumed that cold start node B starts 50 ms after activation and cold start node A does not start until 210 ms after activation. The cycle time is 5 ms.
Node A is able to transmit at the earliest 240 ms (210 ms+6·5 ms) after activation,
Node B is able to transmit at the earliest 245 ms (210 ms+7·5 ms) after activation, and
Node C is able to transmit at the earliest 250 ms (210 ms+8·5 ms) after activation.

In other words, synchronization cannot begin 50 ms after activation (node B initialized) but instead can only begin 210 ms after activation, although node A is completely initialized. This means that in this example, startup of the communication system is delayed by 32 communication cycles ((210 ms−50 ms) 5 ms) and the actual communication via the communication system may begin only with a delay of 32 communication cycles.

Through example embodiments of the present invention, the result is achieved that startup of the communication system is in any case already concluded eight communication cycles after activation of a subscriber even if no other cold start node is available as a partner for the subscriber. This is achieved by combining two cold start nodes in one hardware and thereby also starting them at the same time. Two complete cold start nodes may then be combined with the complete scope of function in one hardware. Alternatively, however, it is also conceivable that only partial functionalities of the cold start nodes, preferably for the functions of the nodes that are required for synchronization, are combined in the hardware. These partial functionalities may also be implemented through application-specific standard semiconductor circuits, which must possibly be adapted or programmed accordingly. Through suitable hardware support, it is possible to ensure that the cold start of the subscriber occurs in any case immediately after activation or after conclusion of the initialization.

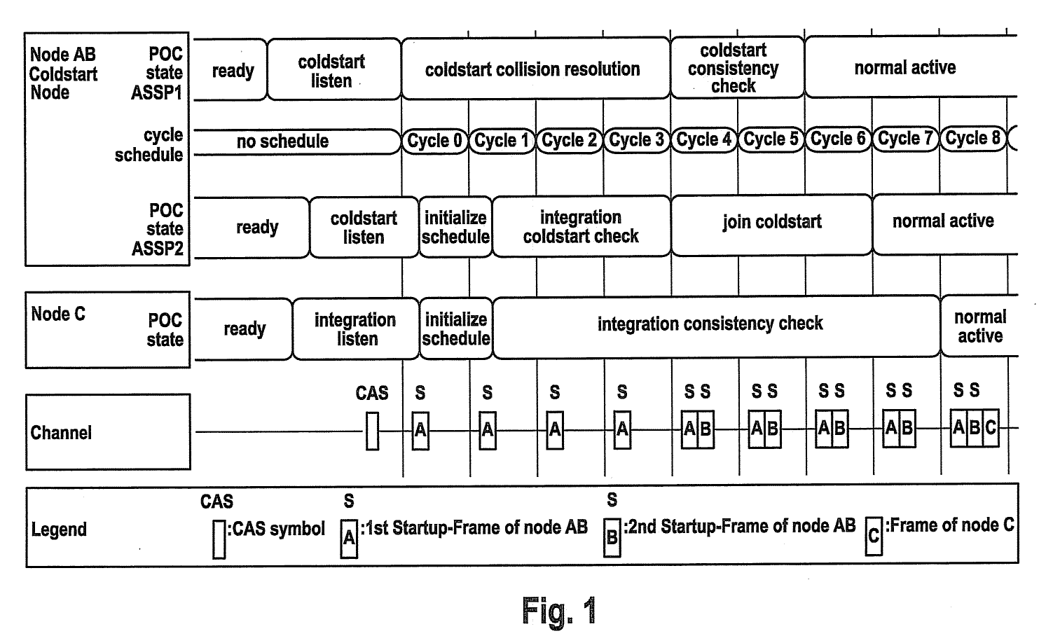

The startup sequence in communication system 1 according to example embodiments of the present invention is explained in greater detail below with reference to FIG. 1. Only one cold start node (node AB here) is necessary which assumes the role of the leading cold start node and transmits a collision avoidance symbol (CAS) if there is no data traffic on the channels. If it is certain that node AB is the only cold start node in the communication network, then the transmission of the CAS may alternatively also be omitted since no other cold start nodes are present to which AB would have to report that it has assumed the role of leader. Thereafter, the first four communication cycles take place, during which node AB transmits a first startup frame in each case. If another node has initiated the startup at the same time and has sent the CAS, then the nodes now detect this and make sure that only one, namely node AB, continues the startup.

During the first four cycles—if any other cold start nodes are present—they have the option to become synchronized to the first synchronization frames. Node AB next begins to transmit the second startup frame in the fifth cycle. Node AB now has the option of becoming synchronized to the second synchronization frame because it is receiving frames for the first time. In this example embodiment, node AB thus becomes synchronized to the second synchronization frame during the fifth and sixth cycles. Alternatively, it would also be possible that node AB becomes synchronized to the first synchronization frames during the first four cycles and then no synchronization of node AB would take place in the fifth and sixth cycles.

Node AB thus has means for generating the different synchronization frames. Through the means for generating the second synchronization frame, the presence of another cold start node or the presence of other synchronization frames of another cold start node is simulated for node AB. The synchronization operation may therefore take place normally except that the simulated node is additionally integrated into single cold start node AB. Node AB is synchronized in the fifth and sixth cycles or in the first through fourth cycles, so that node AB may then begin normal data transmission in the seventh cycle or the eighth cycle. All other FlexRay communication partner nodes are only so-called integrating nodes, which are synchronized to the global time predefined by node AB.

The method according to example embodiments of the present invention for starting communication system 1 has major advantages in comparison with the previous method for the following reasons in particular. Only subscribers present in all the equipment of a motor vehicle, a building, a machine tool, etc., depending on the area of use of the communication system, may be used as startup nodes. In particular, subscribers which are only optional devices of the communication system may not be used. Typical devices in a motor vehicle which may be used as cold start nodes include nodes of the brake system, the engine controller, a gateway, etc. However, these devices in particular are relatively complex and need a great deal of time for self-testing and for full initialization before actual communication may begin according to the implemented protocol specification. In the related art, the second fastest startup node would determine the time after which communication is possible, which may possibly be very delayed. This is where example embodiments of the present invention may remedy the situation, because according to example embodiments of the present invention, a single subscriber is sufficient for synchronization and therefore communication may start sooner. It is no longer necessary to wait for the second fastest node because communication between the subscriber according to example embodiments of the present invention and a subscriber which is virtually not present may be initiated without delay (beyond the time required for synchronization according to the protocol specification being used) at the earliest possible point in time.

Example embodiments of the present invention are explained in greater detail below on the basis of a concrete example. Communication system 1 according to example embodiments of the present invention has at least one special subscriber 3a (cold start node AB) which starts 50 ms after being activated. A cycle time of 5 ms is also assumed.
Node AB may transmit at the earliest 80 ms (50 ms+6·5 ms) after activation (when it is synchronized to the second synchronization frame in the fifth and sixth cycles), and
Node C as an integrated node is synchronized to the time base predefined by node AB and may transmit at the earliest 90 ms (50 ms+8·5 ms) after being activated.

For node C, this yields a time gain of 160 ms (250 ms−90 ms) or 32 communication cycles in comparison with the numerical example given above for the related art.

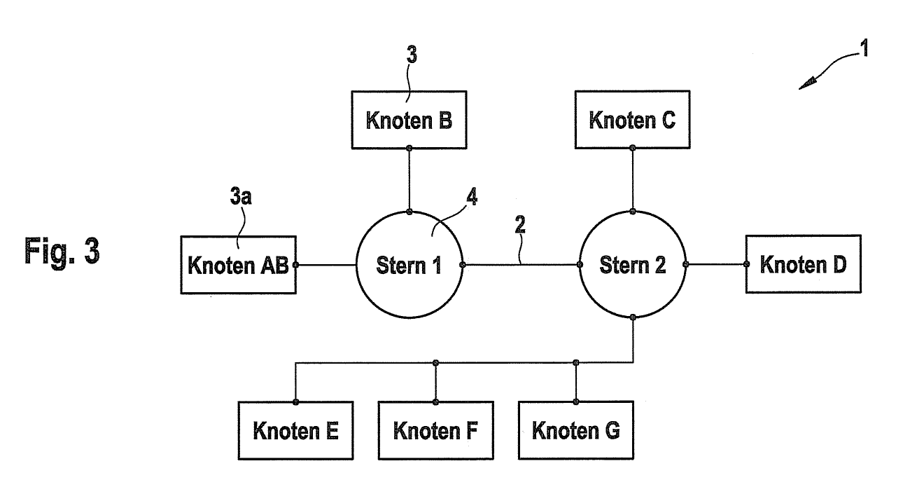

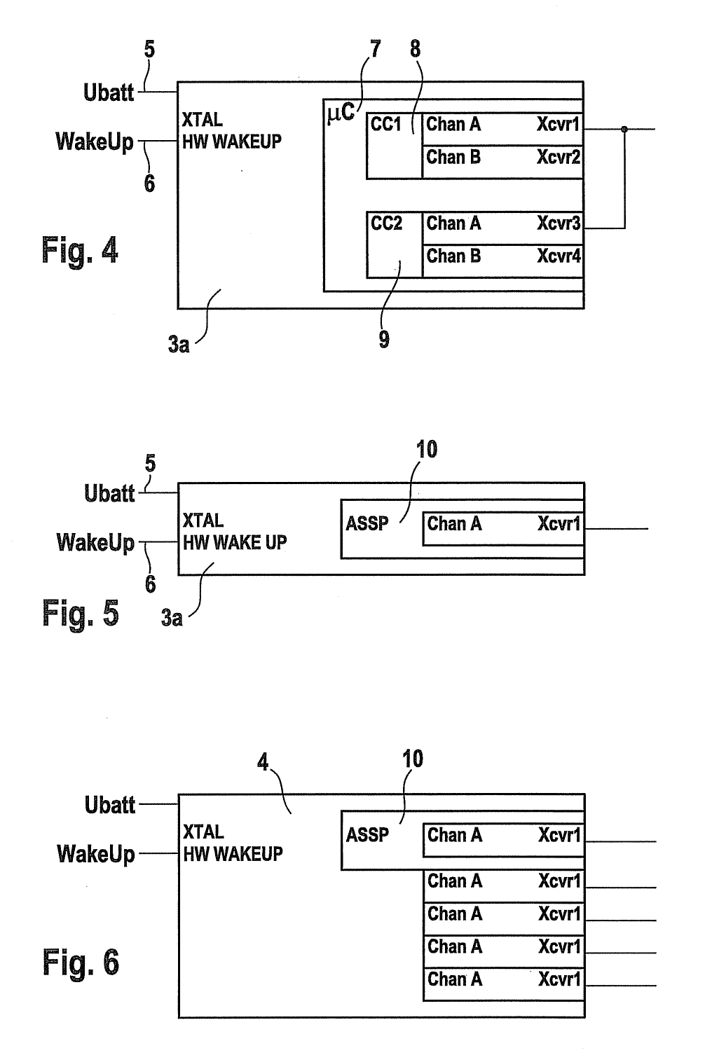

FIGS. 4 through 6 show various example embodiments of a subscriber according to the present invention having device(s) for generating and transmitting two different synchronization frames per communication cycle and per communication channel (Chan A or Chan B). According to FIG. 4, the subscriber is designed as a node 3a. Node 3a has a quartz oscillator (XTAL) as well as two inputs 5, 6 for a power supply voltage (Ubatt) and an external wakeup signal (WakeUp). Node 3a also has a microcontroller 7 and two separate communication controllers 8, 9 (CC1 and (CC2). Each communication controller 8, 9 has a separate transceiver unit (Xcvr1, Xcvr2, Xcvr3 or Xcvr4) for each of the two channels A, B. Node 3a may generate a first synchronization frame via first communication controller 8 and a second communication frame via second communication controller 9 and transmit it on the same channel (Chan A) via the communication medium. Since one communication controller 8, 9 cannot generate two different synchronization frames, two separate communication controllers 8, 9 must be provided in the specific embodiment according to FIG. 4 to comply with the “no single point of failure” requirement.

In the example embodiment in FIG. 5, the at least one subscriber of communication system 1, having means for transmitting two different synchronization frames per communication cycle and per channel, is designed as a network node 3a. However, in the example embodiment according to FIG. 5, instead of two separate communication controllers 8, 9, a so-called application-specific standard product (ASSP) 10 is used. This is a standard integrated circuit, which is available in general and is used for the purpose of generating and transmitting at least two different synchronization frames per communication cycle and per communication channel. It is quite possible that integrated circuit 10 is not compliant with the implemented protocol specification. However, integrated circuit 10 must support the synchronization procedure according to the implemented protocol specification, so that no error message is triggered by synchronization of single node 3a in communication system 1 or the synchronization is delayed until other cold start nodes have concluded their initialization.

Integrated circuit 10 (ASSP) shown in FIG. 5 may be divided between two separate integrated circuits (ASSP1 and ASSP2) as illustrated in FIG. 1 for node AB or the integrated circuits (ASSP1 and ASSP2) shown in FIG. 1 may also be designed as a single integrated circuit 10. The example embodiment shown in FIG. 5 is an approach that has been optimized in comparison with the example embodiment in FIG. 4. No communication controller 8, 9 is used here; integrated circuit 10 may instead implement only wakeup and startup operations; however, it is able to generate two sync null frames per communication cycle. Subscriber 3a may thus function as a leading cold start node (so-called sync master), which performs the synchronization and may thus start the communication in the communication system (with subscribers that are virtually not present).

FIG. 6 shows an example embodiment of a subscriber according to the present invention. Instead of a network node as a subscriber, an active star coupler 4 functions as the subscriber. One communication channel is distributed among multiple physical segments. To this end, star coupler 4 has a transceiver (Xcvr1). In the specific embodiment from FIG. 6, star coupler 4 has an application-specific standard product (ASSP) 10 which is responsible for generating the two different synchronization frames per communication cycle. Instead of integrated circuit 10, star coupler 4 may also, however, have two separate communication controllers (CC1 and CC2) according to the exemplary embodiment in FIG. 4.

1-12. (canceled)

13. A communication system, comprising:
a communication medium; and
at least two subscribers connected to the communication medium; and
a device adapted to generate at least two different synchronization frames per communication cycle in at least one of the subscribers;
wherein communication system is adapted to transmit data among the subscribers via the communication medium in communication frames of communication cycles via a time-triggered protocol

14. The communication system according to claim 13, wherein the device adapted to generate at least two different synchronization frames per communication cycle includes at least two communication controllers per transmission channel.

15. The communication system according to claim 13, wherein the device adapted to generate at least two different synchronization frames per communication cycle includes at least one application-specific standard product adapted to generate at least two different synchronization frames per communication cycle.

16. The communication system according to claim 13, wherein the at least one subscriber is arranged as an active star coupler of the communication system.

17. The communication system according to claim 13, wherein the communication system is adapted to transmit data between the subscribers via a FlexRay protocol.

18. A subscriber connected to a communication medium of a communication system, the communication system having at least one other subscriber connected to the communication medium and being adapted to transmit data among the subscribers via the communication medium in communication frames of communication cycles via a time-triggered protocol, comprising:
a device adapted to generate at least two different synchronization frames per communication cycle.

19. The subscriber according to claim 18, wherein the device includes at least two communication controllers per transmission channel.

20. The subscriber according to claim 18, wherein the device includes at least one application-specific standard product adapted to generate at least two different synchronization frames per communication cycle.

21. The subscriber according to claim 18, wherein the at least one subscriber is arranged as an active star coupler of the communication system.

22. The subscriber according to claim 18, wherein the communication system is adapted to transmit data among the subscribers via a FlexRay protocol.

23. A method for starting up a communication system, having a communication medium and at least two subscribers connected to the communication medium, comprising:
activating, initializing, and synchronizing at least two of the subscribers during startup of the communication system; and
transmitting data among the subscribers after startup via the communication medium in communication frames of communication cycles by using a time-triggered protocol;
wherein one subscriber of the communication system is activated and initialized and the subscriber then transmits for synchronization at least two different synchronization frames per communication cycle, the subscriber being synchronized to one of the two synchronization frames and then being ready for data transmission.

24. The method according to claim 23, wherein the subscriber is initialized and synchronized immediately after being activated.
